(19) United States
(12) Patent Application Publication
(10) Pub. No.: US 2026/0254368 A1
(43) Pub. Date: Aug. 27, 2026

(54) RESONANCE SUPPRESSION METHOD AND SYSTEM FOR GRID-FORMING CONVERTER SYSTEM BASED ON SEQUENCE IMPEDANCE REMODELING

(71) Applicant: Shandong University, Jinan (CN)

(72) Inventors: Xiangyang XING, Jinan (CN); Jing HUI, Jinan (CN); Rui ZHANG, Jinan (CN)

(73) Assignee: Shandong University, Jinan (CN)

(21) Appl. No.: 19/457,199

(22) Filed: Jan. 23, 2026

(30) Foreign Application Priority Data
Feb. 26, 2025 (CN) 202510217731X

(51) Int. Cl. H02M 7/48

(52) U.S. Cl. CPC H02M 7/4811

(57) ABSTRACT

The present disclosure discloses a resonance suppression method and system for a grid-forming converter system based on sequence impedance remodeling. The method comprises: obtaining grid-side voltage, grid-side current and converter-side current small signals after linearization based on a grid-forming converter active and reactive control strategy and a voltage and current dual-closed-loop control principle, and building a sequence impedance model of a grid-forming converter system output impedance based on a virtual synchronous generator; determining conditions for system stability based on the sequence impedance model in combination with a passive theory; and introducing an active damping feedback loop into a voltage control link of a grid-forming converter in combination with the conditions for system stability and remodeling an equivalent output impedance of converter resonance control to reduce a non-passive area of output positive and negative sequence impedances and achieve harmonic resonance suppression of a grid-connected current of the grid-forming converter.

### CROSS-REFERENCE TO RELATED APPLICATIONS

The application claims priority to Chinese patent application No. 202510217731X, filed on Feb. 26, 2025, the entire contents of which are incorporated herein by reference.

### TECHNICAL FIELD

The present disclosure relates to the technical field of resonance suppression of grid-forming converters, in particular to a resonance suppression method and system for a grid-forming converter system based on sequence impedance remodeling.

### BACKGROUND

The statement of this part merely provides background art information related to the present disclosure and does not necessarily constitute the prior art.

The grid-forming control technology enables a converter system to have the capability of regulating the grid-connected frequency and voltage while grid connection, and as the permeability of the new energy source increases in a grid, it gives a grid-connected system a certain support capability, so that the advantage of improving the stability of the grid-connected system allows it to be a hot topic of current research. However, its more comprehensive control strategy also brings more possibilities to make the system unstable and thus generate harmonic resonance.

In order to perform harmonic resonance control on a grid-connected system of a complex grid-forming converter, considering the complexity of a control model thereof, most of the resonance suppression methods refer to a grid-connected system of a grid-following converter, and harmonic analysis and suppression are performed from a voltage and current closed-loop control part, which lacks global consideration. Moreover, a state space analysis method used in analysis methods that take into account the global impedance to some extent will greatly increase the complexity of a modeling process thereof, and the difficulty of modeling causes it difficult to clarify a stability mechanism of the grid-connected system of the complex grid-forming converter. Furthermore, the use of existing virtual damping, a notch filter and the like is difficult to effectively suppress the influence of harmonic resonance in the grid-connected process.

### SUMMARY

In order to solve the above problems, the present disclosure provides a resonance suppression method and system for a grid-forming converter system based on sequence impedance remodeling. A sequence impedance model is built from positive and negative sequence small signals in combination with a grid-forming virtual synchronous generator control strategy. By introducing a passive damping feedback loop, the passivity of the system is increased; a system sequence impedance model is specifically changed by introducing an equivalent feedback loop in combination with the notch filter to suppress system harmonic resonance, thereby reducing a sequence impedance non-passive area and enhancing the stability of the grid-connected system to suppress resonance.

In some implementations, the following technical solutions are adopted:

A resonance suppression method for a grid-forming converter system based on sequence impedance remodeling, including:
obtaining grid-side voltage, grid-side current and converter-side current small signals after linearization based on a grid-forming converter active and reactive control strategy and a voltage and current dual-closed-loop control principle, and building a sequence impedance model of a grid-forming converter system output impedance based on a virtual synchronous generator;
determining conditions for system stability based on the sequence impedance model in combination with a passive theory; and
introducing an active damping feedback loop into a voltage control link of a grid-forming converter in combination with the conditions for system stability and remodeling an equivalent output impedance of converter resonance control to reduce a non-passive area of output positive and negative sequence impedances and achieve harmonic resonance suppression of a grid-connected current of the grid-forming converter.

As an optional solution, specific processes of building the sequence impedance model of the grid-forming converter system output impedance based on the virtual synchronous generator are as follows:
building a nonlinear relationship model of an internal potential, an output terminal voltage and an output current of the grid-forming converter based on the grid-forming converter active and reactive control strategy and the voltage and current dual-closed-loop control principle;
injecting positive sequence and negative sequence disturbance voltages on a grid side of the grid-connected system, and performing harmonic linearization processing on the nonlinear model to respectively obtain the grid-side voltage, grid-side current and converter-side current small signals; and
enabling the small signals to traverse an active and reactive control process and a voltage and current dual-closed-loop control process of the grid-forming converter, and building the sequence impedance model of positive sequence and negative sequence grid-forming converter output impedances in a static coordinate system.

After enabling the small signals to traverse the active and reactive control process and the voltage and current dual-closed-loop control process of the grid-forming converter, the specific processes further include:
respectively substituting dq-axis grid-side voltage small signals Δv_{d} and Δv_{q}, dq-axis grid-side current small signals Δi_{gd} and Δi_{gq}, and inverter-side current small signals Δi_{d} and Δi_{q} obtained after the harmonic linearization processing into active frequency modulation, reactive voltage regulation and current and voltage control processes, and then substituting an obtained small signal model into a converter main circuit equation to obtain the sequence impedance model of the positive sequence and negative sequence grid-forming converter output impedances in the static coordinate system.

As an optional solution, determining the conditions for system stability based on the sequence impedance model in combination with the passive theory is specifically performed as follows: the system is stable when system output positive and negative sequence impedance phases are both within a passive range.

As an optional solution, after introducing the active damping feedback loop, the voltage and current dual-closed-loop control process becomes:

$$\{ \begin{matrix}{Δ𝒰}_{d} ( s ) = {G}_{i} ( s ) ( Δ {i}_{dref} ( s ) - Δ {i}_{d} ( s ) ) - {ω}_{1} {L}_{f} Δ {i}_{q} ( s ) + Δ {v}_{d} ( s ) - {s}^{2} {K}_{a} Δ {i}_{g d} ( s ) \\ {Δ𝒰}_{q} ( s ) = {G}_{i} ( s ) ( Δ {i}_{qref} ( s ) - Δ {i}_{q} ( s ) ) + {ω}_{1} {L}_{f} Δ {i}_{d} ( s ) + Δ {v}_{q} ( s ) - {s}^{2} {K}_{a} Δ {i}_{g q} ( s )\end{matrix} ;$$

where ω₁ is a rated angular frequency, L_{f} is a converter-side series inductance, s²Kₐ represents introduced active damping feedback, and Kₐ is an active damping parameter; and Δ [symbol] _{d}(s) and Δ [symbol] _{q}(s) are respectively small signals after dq-axis modulation voltage linearization, Gᵢ(s) is a current loop transfer function, Δi_{dref}(s) and Δi_{qref}(s) are respectively reference current input of dq-axis current loop linearization small signals, Δi_{d} and Δi_{q} are respectively inverter-side current small signals obtained after harmonic linearization processing, Δv_{d}(s) and Δv_{q}(s) are respectively dq-axis grid-side voltage small signals obtained after harmonic linearization processing, and Δi_{gd}(s) and Δi_{gq}(s) are respectively dq-axis grid-side current small signals obtained after harmonic linearization processing.

As an optional solution, the specific processes further include: introducing a virtual notch filter in a voltage and current control link of the grid-forming converter, such that output positive and negative sequence impedances meet a phase margin requirement.

After introducing the virtual notch filter, the voltage and current dual-closed-loop control process becomes:

$$\{ \begin{matrix}{Δ𝒰}_{d} ( s ) = {G}_{i} ( s ) ( Δ {i}_{d r e f} ( s ) - Δ {i}_{d} ( s ) ) - {ω}_{1} {L}_{f} Δ {i}_{q} ( s ) + \\ Δ {v}_{d} ( s ) - ( {s}^{2} {K}_{a} + s {L}_{f} ) {G}_{N o r} ( s ) Δ {i}_{q d} ( s ) + s {L}_{f} Δ {i}_{q d} ( s ) \\ {Δ𝒰}_{q} ( s ) = {G}_{i} ( s ) ( Δ {i}_{q r e f} ( s ) - Δ {i}_{q} ( s ) ) + {ω}_{1} {L}_{f} Δ {i}_{d} ( s ) + \\ Δ {v}_{q} ( s ) - ( {s}^{2} {K}_{a} + s {L}_{f} ) {G}_{N o r} ( s ) Δ {i}_{q q} ( s ) + s {L}_{f} Δ {i}_{q q} ( s )\end{matrix} ;$$

where ω₁ is a rated angular frequency, L_{f} is a converter-side series inductance, s²Kₐ represents introduced active damping feedback, and Kₐ is an active damping parameter; G_{Nor}(s) is a notch filter model; and Δ [symbol] _{d}(s) and Δ [symbol] _{q}(s) are respectively small signals after dq-axis modulation voltage linearization, Gᵢ(s) is a current loop transfer function, Δi_{dref}(s) and Δi_{qref}(s) are respectively reference current input of dq-axis current loop linearization small signals, Δi_{d} and Δi_{q} are respectively inverter-side current small signals obtained after harmonic linearization processing, Δv_{d}(s) and Δv_{q}(s) are respectively dq-axis grid-side voltage small signals obtained after harmonic linearization processing, and Δi_{gd}(s) and Δi_{gq}(s) are respectively dq-axis grid-side current small signals obtained after harmonic linearization processing.

In some other implementations, the following technical solutions are adopted:

A resonance suppression system for a grid-forming converter system based on sequence impedance remodeling, including:
a model building module for obtaining grid-side voltage, grid-side current and converter-side current small signals after linearization based on a grid-forming converter active and reactive control strategy and a voltage and current dual-closed-loop control principle, and building a sequence impedance model of a grid-forming converter system output impedance based on a virtual synchronous generator;
a stability analysis module for determining conditions for system stability based on the sequence impedance model in combination with a passive theory; and
a resonance suppression module for introducing an active damping feedback loop into a voltage control link of a grid-forming converter in combination with the conditions for system stability and remodeling an equivalent output impedance of converter resonance control to reduce a non-passive area of output positive and negative sequence impedances and achieve harmonic resonance suppression of a grid-connected current of the grid-forming converter.

In some other implementations, the following technical solutions are adopted:
Terminal equipment, including a processor and a memory, the processor being used for implementing instructions, and the memory being used for storing a plurality of instructions, where the instructions are adapted to be loaded by the processor and to execute the resonance suppression method for a grid-forming converter system based on sequence impedance remodeling described above.

In some other implementations, the following technical solutions are adopted:

A computer-readable storage medium, having a plurality of instructions stored therein, where the instructions are adapted to be loaded by a processor of terminal equipment and to execute the resonance suppression method for a grid-forming converter system based on sequence impedance remodeling described above.

Compared with the prior art, the present disclosure has the beneficial effects as follows:
(1) According to the present disclosure, aiming at the grid-connected system of the grid-forming converter based on the virtual synchronous generator, the system's sequence impedance model is built by using harmonic linearization and small signal thinking, and the conditions for system stability are determined in combination with the passive theory to first use the sequence impedance model to perform impedance remodeling of the grid-connected system; and a feedback control loop of equivalent series virtual damping and an equivalent notch filter are specifically introduced into the converter system to perform sequence impedance waveform remodeling, thereby controlling stability and robustness of the system.
(2) According to the present disclosure, in the analysis of the system stability mechanism, sequence impedance modeling is used for ensuring the globality and accuracy, and meanwhile, the nonlinear model is linearized to reduce the modeling complexity.
(3) According to the present disclosure, an active damping feedback loop is introduced to remould the equivalent output impedance of the converter resonance control to reduce its non-passive area and increase the system's passivity; and at the same time, a virtual equivalent notch filter is introduced, so that the output impedance of the system during grid connection has sufficient phase margins, the stability and robustness of the system are improved, and the harmonic resonance of the system is suppressed.
(4) Compared with traditional passive and active damping methods, the present disclosure does not need hardware such as resistors and additional sensors and reduces costs and losses of the system.

Other features and additional advantages of the present disclosure will be partially described below, and some will become apparent from the description below, or will be understood through the practice of this aspect.

### BRIEF DESCRIPTION OF THE DRAWINGS

FIG. 1 is a structure diagram of a control system of a virtual synchronous generator of a grid-forming converter in an embodiment of the present disclosure;

FIG. 2 is a topology structure diagram of a main circuit of the grid-forming converter in an embodiment of the present disclosure;

FIG. 3 is a topology structure diagram of a main circuit of the grid-forming converter in an embodiment of the present disclosure;

FIG. 4 is an equivalent circuit model diagram of positive and negative sequence small signals of the grid-forming converter system in an embodiment of the present disclosure;

FIG. 5(a) is a control block diagram of a grid-forming converter system introducing a series passive damping current and voltage in an embodiment of the present disclosure;

FIG. 5(b) is a control block diagram of a grid-forming converter system introducing an equivalent active damping feedback loop in an embodiment of the present disclosure;

FIG. 6 is a bode chart of an output sequence impedance waveform of the grid-forming converter system changed along with active damping parameters in an embodiment of the present disclosure;

FIG. 7 is an interaction characteristic chart of a system's sequence impedance and a grid-side inductance after the grid-forming converter system selects appropriate active damping parameters in an embodiment of the present disclosure;

FIG. 8 is a waveform chart of a notch filter used in the grid-forming converter system changed along with the parameters in an embodiment of the present disclosure;

FIG. 9(a) is a control block diagram of the grid-forming converter system introducing a notch filter current and voltage in an embodiment of the present disclosure;

FIG. 9(b) is a control block diagram of the grid-forming converter system introducing an equivalent notch filter feedback loop in an embodiment of the present disclosure;

FIG. 10 is a bode chart of a system's output sequence impedance changed along with the parameters after equivalent notch filter feedback is introduced into the grid-forming converter system in an embodiment of the present disclosure;

FIG. 11(a) is a waveform chart of a grid-side output current before harmonic suppression of the grid-forming converter system in an embodiment of the present disclosure;

FIG. 11(b) is a waveform chart of the grid-side output current after active damping is used in the grid-forming converter system in an embodiment of the present disclosure;

FIG. 11(c) is a waveform chart of a grid-side output current after the notch filter is introduced into the grid-forming converter system in an embodiment of the present disclosure;

FIG. 11(d) is THD of the grid-side output current after active damping is used in the grid-forming converter system in an embodiment of the present disclosure; and

FIG. 11(e) is THD of the grid-side output current after the notch filter is introduced into the grid-forming converter system in an embodiment of the present disclosure.

### DETAILED DESCRIPTION OF THE EMBODIMENTS

It should be noted that the following detailed description is exemplary and intended to further illustrate the present application. Unless otherwise specified, all technical and scientific terms used in the present disclosure have the same meanings as those commonly understood by those skilled in the relevant technical field.

It should be noted that the terms used herein are only for describing the implementations rather than for limiting the exemplary implementations of the present application. As used herein, unless otherwise explicitly indicated by the context, the singular form is intended to include the plural form as well. In addition, it should be understood that when the terms “comprise” and/or “include” are used in this specification, they indicate the presence of features, steps, operations, devices, components, and/or their combinations.

### Embodiment 1

In one or more implementations, disclosed is a resonance suppression method for a grid-forming converter system based on sequence impedance remodeling, specifically including the processes as follows:
S101: Build a sequence impedance model of a grid-forming converter system output impedance by using grid-side voltage, grid-side current and converter-side current small signals obtained after linearization through harmonic linearization processing based on a grid-forming converter active and reactive control strategy and a voltage and current dual-closed-loop control principle.

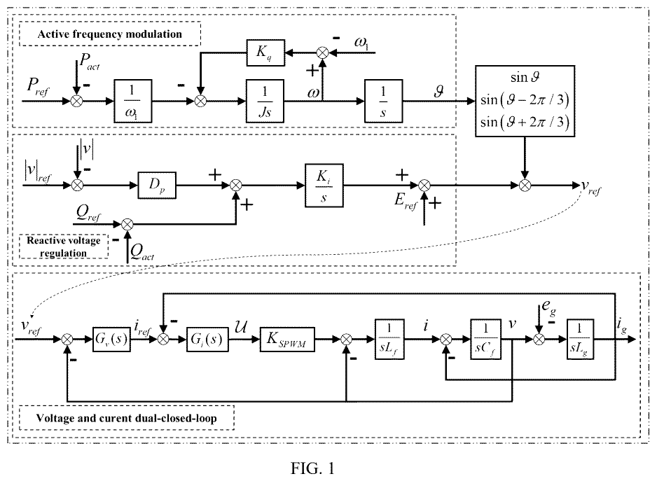

Specifically, FIG. 1 presents a structure of a control system of a virtual synchronous generator of the grid-forming converter, including: an active frequency regulation process, a reactive voltage regulation control process and a voltage and current dual-closed-loop decoupling control process.

Among them, the active frequency regulation process is specifically as follows:

$$ϑ ( s ) = \frac{1}{s ( J s + {D}_{p} )} ( \frac{{P}_{r e f}}{{ω}_{1}} - \frac{{P}_{a c t}}{{ω}_{1}} + {D}_{p} {ω}_{1} ) \qquad ( 1 )$$

in the formula, ϑ is an internal potential phase angle of the virtual synchronous generator, ω₁ is a rated angular frequency, P_{ref} is a given active power of the virtual synchronous generator, P_{act} is a system's output active power, Dₚ is a damping coefficient, and J is a rotational inertia of the virtual synchronous generator.

The reactive voltage regulation control process is specifically as follows:

$${E}_{m} ( s ) = \frac{{K}_{i}}{s} ( {Q}_{r e f} - {Q}_{act} ) + \frac{{K}_{i} {K}_{q}}{s} ( {\vert v \vert}_{r e f} - \vert v \vert ) + {E}_{r e f} \qquad ( 2 )$$

where Eₘ is an effective value of a virtual internal potential, Kᵢ is an excitation integration coefficient of the virtual synchronous generator, |v|_{ref} is an effective value of a rated voltage, |v| is an effective value of a grid-connected voltage, Kg is a reactive-voltage droop coefficient, Q_{ref} is a system's given reactive power, and Q_{act} is a system's output reactive power.

The voltage and current dual-closed-loop decoupling control process is specifically as follows:

$$\begin{matrix}\{ \begin{matrix}{i}_{d r e f} ( s ) = {G}_{v} ( s ) ( {v}_{d r e f} ( s ) - {v}_{d} ( s ) ) - {ω}_{1} {C}_{f} {v}_{q} ( s ) + {i}_{ℊ d} ( s ) \\ {i}_{q r e f} ( s ) = {G}_{v} ( s ) ( {v}_{q r e f} ( s ) - {v}_{q} ( s ) ) + {ω}_{1} {C}_{f} {v}_{d} ( s ) + {i}_{ℊ q} ( s )\end{matrix} \\ \{ \begin{matrix}{𝒰}_{d} ( s ) = {G}_{i} ( s ) ( {i}_{d r e f} ( s ) - {i}_{d} ( s ) ) - {ω}_{1} {L}_{f} {i}_{q} ( s ) + {v}_{d} ( s ) \\ {𝒰}_{q} ( s ) = {G}_{i} ( s ) ( {i}_{q r e f} ( s ) - {i}_{q} ( s ) ) + {ω}_{1} {L}_{f} {i}_{d} ( s ) + {v}_{q} ( s )\end{matrix}\end{matrix} \qquad ( 3 )$$

where C_{f} is a three-phase parallel capacitor, L_{f} is a converter-side series inductance, a capacitor voltage v_{abc} under a dq axis is v_{d} and v_{q}, a converter-side current i_{abc} under the dq axis is i_{d} and i_{q}, the grid-side current i_{gabc} under the dq axis is i_{gd} and i_{gq}, v_{dref} and v_{qref} are output voltages under the dq axis in the reactive voltage regulation process, U_{d} and U_{q} are respectively final dq-axis modulation voltages, Gᵥ(s) and Gᵢ(s) are respectively PI integral controllers of a voltage loop and a current loop, with their proportional coefficients being Kₚᵤ and Kₚᵢ respectively, and integral coefficients being Kᵢᵤ and Kᵢᵢ respectively; and i_{dref} and i_{qref} are respectively dq-axis voltage external loop output, that is, dq-axis current loop linearized small-signal reference current input.

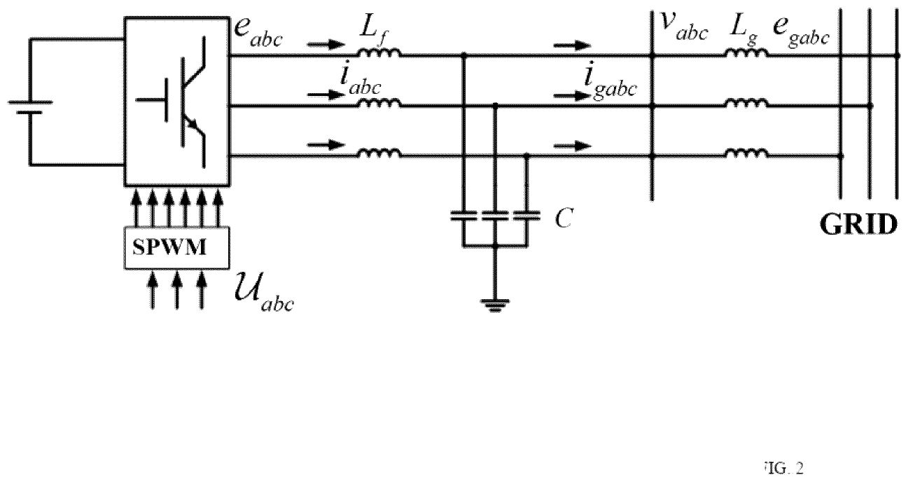

FIG. 2 presents a topology structure of a converter grid-connected main circuit. Firstly, a nonlinear grid-forming converter grid-connected control system undergoes harmonic linearization processing. If positive and negative sequence disturbance voltages are injected into the grid side of the grid-connected system, taking an a-phase as an example, the grid-side voltage becomes:

$${v}_{a b c} = {V}_{1} cos ( 2 π {f}_{1} t ) + {V}_{p} cos ( 2 π {f}_{p} t + {ϕ}_{v p} ) + {V}_{n} cos ( 2 π {f}_{n} t + {ϕ}_{v n} ) \qquad ( 4 )$$

in the formula, v_{abc} is a grid-side voltage (i.e., a capacitor voltage), V₁, Vₚ and Vₙ are an amplitude of a fundamental wave, an amplitude of a positive sequence disturbance, and an amplitude of a negative sequence disturbance of the grid-side voltage, respectively, f₁, fₚ and fₙ are a corresponding frequency, respectively, and φᵥₚ and φᵥₙ are a positive and negative sequence disturbance phase angle, respectively.

Similarly, for a grid-side current i_{gabc}, an amplitude of a fundamental wave, an amplitude of a positive sequence disturbance, and an amplitude of a negative sequence disturbance are I_{g1}, I_{gp} and I_{gn}, respectively, positive and negative sequence disturbance phase angles are φ_{igp} and φ_{ign}, respectively, and a fundamental wave disturbance phase angle is φ_{ig1};

For a converter-side current i_{abc}, an amplitude of a fundamental wave, an amplitude of a positive sequence disturbance, and an amplitude of a negative sequence disturbance are I₁, Iₚ and Iₙ, respectively, positive and negative sequence disturbance phase angles are φᵢₚ and φᵢₙ, and a fundamental wave disturbance phase angle is φᵢ₁.

For each voltage and current v_{abc}, i_{gabc} and i_{abc} at a disturbance position, a Fourier transformation and a coordinate transformation are performed respectively to convert each voltage and current into voltage and current components under a zero sequence, a positive sequence, and a negative sequence, and then small signals of each part are obtained; and then considering a frequency offset effect in a coordinate transformation, an instantaneous output power P_{act} and Q_{act} of the control system are calculated as follows:

$${P}_{act} [ f ] = \{ \begin{matrix}{p}_{avg} , f = 0 \\ \frac{3}{2} ( {I}_{ℊ1} cos {ϕ}_{i ℊ1} ∓ {jI}_{ℊ1} sin {ϕ}_{i ℊ1} ) {v}_{p} + \frac{3}{2} {V}_{1} {𝒥}_{ℊ p} , f = \pm ( {f}_{p} - {f}_{1} ) \\ \frac{3}{2} ( {I}_{ℊ1} cos {ϕ}_{i ℊ1} \pm {jI}_{ℊ1} sin {ϕ}_{i ℊ1} ) {v}_{n} + \frac{3}{2} {V}_{1} {𝒥}_{ℊ n} , f = \pm ( {f}_{n} - {f}_{1} )\end{matrix} \qquad ( 5 )$$

$${Q}_{act} [ f ] = \{ \begin{matrix}{Q}_{avg ,} f = 0 \\ \frac{3 j}{2} ( ∓ {I}_{ℊ1} cos {ϕ}_{i ℊ1} + {jI}_{ℊ1} sin {ϕ}_{i ℊ1} ) {v}_{p} \pm \frac{3}{2} {V}_{1} {𝒥}_{ℊ p} , f = \pm ( {f}_{p} - {f}_{1} ) \\ \frac{3 j}{2} ( \pm {I}_{ℊ1} cos {ϕ}_{i ℊ1} \pm {jI}_{ℊ1} sin {ϕ}_{i ℊ1} ) {v}_{n} ∓ \frac{3}{2} {V}_{1} {𝒥}_{ℊ n} , f = \pm ( {f}_{n} - {f}_{1} )\end{matrix} \qquad ( 6 )$$

where V₁=V₁/2, Vₚ=Vₚe^{±jφ}^{ᵥₚ}/2, Vₙ=Vₙe^{±jφ}^{ᵥₙ}/2, I_{g1}=I_{g1}e^{±jφ}^{_{ig1}}/2, [symbol] _{gp}=I_{gp}e^{±jφ}^{_{igp}}/2, [symbol] _{gn}=I_{gn}e^{±jφ}^{_{ign}}/2; P_{avg}, Q_{avg}, φ_{ig1} and f represent an average active power, an average reactive power, a grid-side current fundamental wave disturbance phase angle and a frequency independent variable, respectively.

dq-axis grid-side voltage small signals Δv_{d} and Δv_{q}, dq-axis grid-side current small signals Δi_{gd} and Δi_{gq}, and inverter-side current small signals Δi_{d} and Δi_{q} obtained after the harmonic linearization processing traverse system active and reactive power control loops and voltage and current control loops, and small signals Δϑ, Δv_{dqref}, Δi_{dqref} and ΔU_{dq} can be obtained in turns:

$$Δϑ [ f ] = \{ \begin{matrix}- \frac{1}{s ( Js + {D}_{p} )} \frac{{P}_{act \_ p}}{ω} , f = \pm ( {f}_{p} - {f}_{1} ) \\ - \frac{1}{s ( Js + {D}_{p} )} \frac{{P}_{act \_ n}}{ω} , f = \pm ( {f}_{n} - {f}_{1} )\end{matrix} \qquad ( 7 )$$

$$\{ \begin{matrix}Δ {v}_{dref} = \{ \begin{matrix}{E}_{m \_ p} , f = \pm ( {f}_{p} - {f}_{1} ) \\ {E}_{m \_ n} , f = \pm ( {f}_{n} - {f}_{1} )\end{matrix} \\ Δ {v}_{qref} = 0\end{matrix} \qquad ( 8 )$$

$$\{ \begin{matrix}Δ {i}_{d r e f} ( s ) = {G}_{v} ( s ) ( Δ {v}_{d r e f} ( s ) - Δ {v}_{d} ( s ) ) - {ω}_{1} {C}_{f} Δ {v}_{q} ( s ) + Δ {i}_{ℊ d} ( s ) \\ Δ {i}_{q r e f} ( s ) = {G}_{v} ( s ) ( Δ {v}_{q r e f} ( s ) - Δ {v}_{q} ( s ) ) + {ω}_{1} {C}_{f} Δ {v}_{d} ( s ) + Δ {i}_{ℊ q} ( s )\end{matrix} \qquad ( 9 )$$

$$\{ \begin{matrix}{Δ𝒰}_{d} ( s ) = {G}_{i} ( s ) ( Δ {i}_{d r e f} ( s ) - Δ {i}_{d} ( s ) ) - {ω}_{1} {L}_{f} Δ {i}_{q} ( s ) + Δ {v}_{d} ( s ) \\ {Δ𝒰}_{q} ( s ) = {G}_{i} ( s ) ( Δ {i}_{q r e f} ( s ) - Δ {i}_{q} ( s ) ) + {ω}_{1} {L}_{f} Δ {i}_{d} ( s ) + Δ {v}_{q} ( s )\end{matrix} \qquad ( 10 )$$

where Δϑ[f] is a small signal variation of an internal potential phase angle of a virtual synchronous generator, J is the moment of inertia of the virtual synchronous generator, and P_{act_p} and P_{act_n} are instantaneous positive and negative sequence output powers of a virtual synchronous generator (VSG) system, respectively; Δv_{dref}(s) and Δv_{qref}(s) are dq-axis output voltage small signals of the reactive voltage regulation process obtained after the harmonic linearization processing, respectively, and E_{m_p} and E_{m_n} are positive and negative sequence virtual internal potentials, respectively; Δi_{dref}(s) and Δi_{qref}(s) are reference current inputs of the dq-axis current loop linearized small signals, respectively, Δv_{d}(s) and Δv_{q}(s) are dq-axis grid-side voltage small signals obtained after the harmonic linearization processing, respectively, and Δi_{gd}(s) and Δi_{gq}(s) are dq-axis grid-side current small signals obtained after the harmonic linearization processing, respectively; and Δ [symbol] _{d}(s) and Δ [symbol] _{q}(s) are small signals after dq-axis modulated voltage linearization, respectively, and Δi_{d} and Δi_{q} are inverter-side current small signals obtained after the harmonic linearization processing, respectively.

According to FIG. 2, a main circuit equation of a system can be obtained as follows:

$$[ \begin{matrix}{𝒰}_{a} \\ {𝒰}_{b} \\ {𝒰}_{c}\end{matrix} ] = ( 1 + {C}_{f} {L}_{f} {s}^{2} ) [ \begin{matrix}{v}_{a} \\ {v}_{b} \\ {v}_{c}\end{matrix} ] + {sL}_{f} [ \begin{matrix}{i}_{ℊ a} \\ {i}_{ℊ b} \\ {i}_{ℊ c}\end{matrix} ] \qquad ( 11 )$$

where C_{f} is the three-phase parallel capacitance, L_{f} is the converter-side series inductance, vₐ, v_{b} and v_{c} are capacitor voltages (i.e., the grid-side voltages v_{abc}) in a three-phase stationary coordinate system, i_{ga}, i_{gb} and i_{gc} are grid-side currents in the three-phase stationary coordinate system; and [symbol] ₐ, [symbol] _{b} and [symbol] _{c} are three-phase modulated voltages in the stationary coordinate system.

By substituting an obtained small signal model into (11) through a coordinate transformation, a system sequence impedance model can be obtained as follows:

$$\{ \begin{matrix}{Z}_{vs ℊ\_ p} ( s ) = \frac{{\text{?}}_{1} ( s - j2 π {f}_{1} ) - ( {L}_{f} s )}{{ℬ}_{1} ( s - j 2 π {f}_{1} ) - {𝒞}_{1} ( s - j 2 π {f}_{1} ) - ( 1 + {L}_{f} {C}_{f} {s}^{2} )} \\ {Z}_{vs ℊ\_ n} ( s ) = \frac{{\text{?}}_{2} ( s - j2 π {f}_{1} ) - ( {L}_{f} s )}{{ℬ}_{2} ( s + j 2 π {f}_{1} ) - {𝒞}_{2} ( s + j 2 π {f}_{1} ) - ( 1 + {L}_{f} {C}_{f} {s}^{2} )}\end{matrix} \qquad ( 12 )$$

in the formula, algebraic expressions are respectively as follows:

$${\text{?}}_{1} = ( \begin{matrix}- {G}_{i} [ f ] {G}_{v} [ f ] \frac{{K}_{i}}{s} [ f ] \frac{3 j}{4} {v}_{1} - {G}_{i} [ f ] {I}_{ℊ1} \frac{cos {ϕ}_{i ℊ1} - sin {ϕ}_{i ℊ1}}{2} \frac{3 N [ f ]}{2 {ω}_{1}} {V}_{1} - \frac{1 - j}{2} \\ + \frac{1 - j}{2} {G}_{i} [ f ] - {I}_{1} \frac{cos {ϕ}_{i 1} - sin {ϕ}_{i 1}}{2} \frac{3 N [ f ]}{2 {ω}_{1}} {V}_{1} - {ω}_{1} {L}_{f} {l}_{1} \frac{cos {ϕ}_{i 1} + sin {ϕ}_{i 1}}{2} \frac{3 N [ f ]}{2 {ω}_{1}} {V}_{1} \\ + \frac{1 + j}{2} {ω}_{1} {L}_{f} + {G}_{i} [ f ] {G}_{v} [ f ] \frac{{K}_{i} {K}_{q}}{s} [ f ] {V}_{p} \frac{3 N [ f ]}{4 {ω}_{1}} {V}_{1} - {G}_{i} [ f ] {ω}_{1} {C}_{f} {V}_{1} \frac{3 N [ f ]}{2 {ω}_{1}} {V}_{1}\end{matrix} ) \qquad ( 13 - 1 )$$

$${\text{?}}_{2} = ( \begin{matrix}+ {G}_{i} [ f ] {G}_{v} [ f ] \frac{{K}_{i}}{s} [ f ] \frac{3 j}{4} {v}_{1} - {G}_{i} [ f ] {I}_{ℊ1} \frac{cos {ϕ}_{i ℊ1} - sin {ϕ}_{i ℊ1}}{2} \frac{3 N [ f ]}{2 {ω}_{1}} {V}_{1} - \frac{1 + j}{2} \\ + \frac{1 + j}{2} {G}_{i} [ f ] - {I}_{1} \frac{cos {ϕ}_{i 1} - sin {ϕ}_{i 1}}{2} \frac{3 N [ f ]}{2 {ω}_{1}} {V}_{1} - {ω}_{1} {L}_{f} {l}_{1} \frac{cos {ϕ}_{i 1} + sin {ϕ}_{i 1}}{2} \frac{3 N [ f ]}{2 {ω}_{1}} {V}_{1} \\ + \frac{1 - j}{2} {ω}_{1} {L}_{f} + {G}_{i} [ f ] {G}_{v} [ f ] \frac{{K}_{i} {K}_{q}}{s} [ f ] {V}_{p} \frac{3 N [ f ]}{4 {ω}_{1}} {V}_{1} - {G}_{i} [ f ] {ω}_{1} {C}_{f} {V}_{1} \frac{3 N [ f ]}{2 {ω}_{1}} {V}_{1}\end{matrix} ) \qquad ( 13 - 2 )$$

$${ℬ}_{1} = ( \begin{matrix}+ {G}_{i} [ f ] {G}_{v} [ f ] \frac{{K}_{i}}{s} [ f ] \frac{3}{2} {𝒥}_{ℊ1}^{*} + \frac{- 1 + j}{2} {G}_{i} [ f ] {G}_{v} [ f ] + \frac{- 1 + j}{2} {G}_{i} [ f ] {ω}_{1} {C}_{f} \\ - {G}_{i} [ f ] {ω}_{1} {C}_{f} {V}_{1} \frac{3 N [ f ]}{{ω}_{1}} {𝒥}_{ℊ1}^{*} + {G}_{i} [ f ] {I}_{ℊ1} \frac{cos {ϕ}_{i ℊ1} - sin {ϕ}_{i ℊ1}}{2} \frac{3 N [ f ]}{{ω}_{1}} {𝒥}_{ℊ1}^{*} \\ + \frac{1 + j}{2} {sC}_{f} + \frac{1 + j}{2} {ω}_{1} {L}_{f} {SC}_{f} - {I}_{1} \frac{cos {ϕ}_{i 1} - sin {ϕ}_{i 1}}{2} \frac{3 N [ f ]}{{ω}_{1}} {𝒥}_{ℊ1}^{*} + \frac{1 + j}{2} j \\ - {ω}_{1} {L}_{f} {I}_{1} \frac{cos {ϕ}_{i 1} + sin {ϕ}_{i 1}}{2} \frac{3 N [ f ]}{{ω}_{1}} {𝒥}_{ℊ1}^{*} + {G}_{i} [ f ] {G}_{v} [ f ] \frac{{K}_{i} {K}_{q}}{s} [ f ] {V}_{p} \frac{3 N [ f ]}{2 {ω}_{1}} {𝒥}_{ℊ1}^{*}\end{matrix} ) \qquad ( 14 - 1 )$$

$${ℬ}_{2} = ( \begin{matrix}- {G}_{i} [ f ] {G}_{v} [ f ] \frac{{K}_{i}}{s} [ f ] \frac{3}{2} {𝒥}_{ℊ1}^{1} + \frac{- 1 - j}{2} {G}_{i} [ f ] {G}_{v} [ f ] + \frac{- 1 - j}{2} {G}_{i} [ f ] {ω}_{1} {C}_{f} \\ - {G}_{i} [ f ] {ω}_{1} {C}_{f} {V}_{1} \frac{3 N [ f ]}{{ω}_{1}} {𝒥}_{ℊ1}^{1} + {G}_{i} [ f ] {I}_{ℊ1} \frac{cos {ϕ}_{i ℊ1} - sin {ϕ}_{i ℊ1}}{2} \frac{3 N [ f ]}{{ω}_{1}} {𝒥}_{ℊ1}^{1} \\ + \frac{1 - j}{2} {sC}_{f} + \frac{1 - j}{2} {ω}_{1} {L}_{f} {SC}_{f} - {I}_{1} \frac{cos {ϕ}_{i 1} - sin {ϕ}_{i 1}}{2} \frac{3 N [ f ]}{{ω}_{1}} {𝒥}_{ℊ1}^{1} + \frac{1 + j}{2} j \\ - {ω}_{1} {L}_{f} {I}_{1} \frac{cos {ϕ}_{i 1} + sin {ϕ}_{i 1}}{2} \frac{3 N [ f ]}{{ω}_{1}} {𝒥}_{ℊ1}^{1} + {G}_{i} [ f ] {G}_{v} [ f ] \frac{{K}_{i} {K}_{q}}{s} [ f ] {V}_{p} \frac{3 N [ f ]}{2 {ω}_{1}} {𝒥}_{ℊ1}^{1}\end{matrix} ) \qquad ( 14 - 2 )$$

$${𝒞}_{1} [ f ] = {G}_{i} [ f ] {G}_{v} [ f ] \frac{{K}_{i} {K}_{q}}{s} [ f ] {e}^{- j {ϕ}_{vp}} , {𝒞}_{2} [ f ] = {G}_{i} [ f ] {G}_{v} [ f ] \frac{{K}_{i} {K}_{q}}{s} [ f ] {e}^{- j {ϕ}_{vn}} \qquad ( 15 )$$

where

$$N [ f ] = \frac{1}{s ( J s + {D}_{p} )}$$

(s and f are both common variables in a frequency domain), Kᵢ is an excitation integral coefficient of the virtual synchronous generator, K_{q} is a reactive-voltage droop coefficient, for the converter-side current i_{abc}, the amplitude of the fundamental wave, the amplitude of the positive sequence disturbance, and the amplitude of the negative sequence disturbance are I₁, Iₚ and Iₙ, respectively, v_{abc} is the grid-side voltage, V₁, Vₚ and Vₙ are the amplitude of the fundamental wave, the amplitude of the positive sequence disturbance, Gᵥ[f] and Gᵢ[f] are PI integral controllers of the voltage loop and the current loop, respectively, and φ_{ig1} and φᵢ₁ are fundamental wave disturbance phase angles of the grid-side current and the converter-side current.

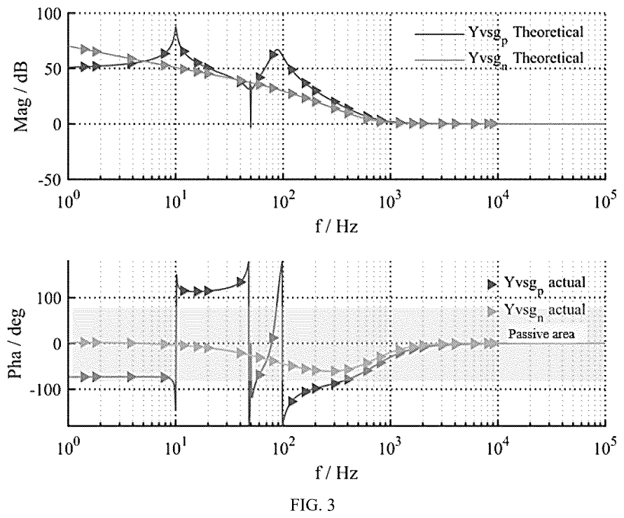

FIG. 3 shows a sequence impedance image of a system sequence impedance theoretical model and a frequency sweep verification, where positive sequence impedances of the model are represented by different colors, respectively, and a derived sequence impedance model fits well with an actual system output sequence impedance verification result, proving a correctness of the theoretical model.
S102: Determine conditions for system stability based on the sequence impedance model in combination with a passive theory.

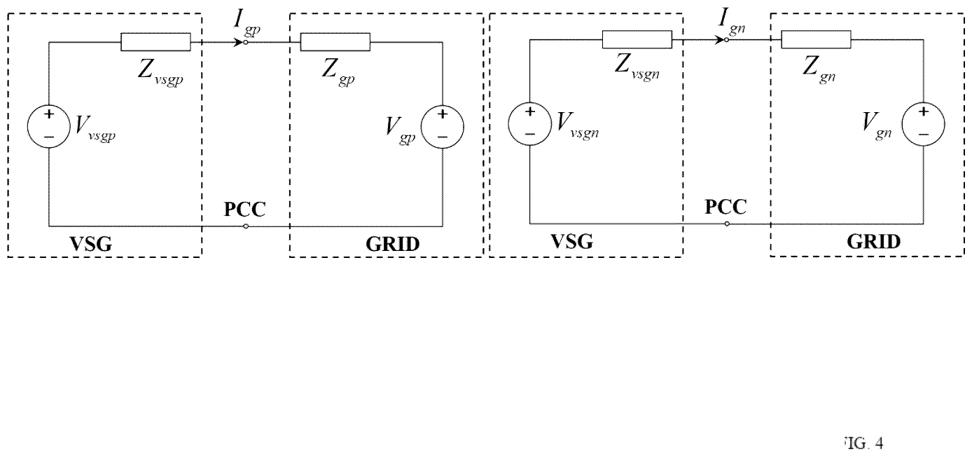

FIG. 4 shows a positive and negative sequence small signal equivalent circuit model of the system, a three-phase converter is decomposed into positive and negative sequence subsystems, positive and negative sequence voltage disturbance sources are connected in series, the positive and negative sequence small signal equivalent circuit includes series connections of positive and negative sequence virtual synchronous generator internal potentials V_{vsgp} and V_{vsgn}, virtual synchronous generator sequence impedances Z_{vsgp} and Z_{vsgn}, positive and negative sequence grid impedances Z_{gp} and Z_{gn}, and positive and negative sequence grid voltages V_{gp} and V_{gn}. According to the equivalent circuit, a relationship between a grid-connected current and a converter system output impedance can be obtained as:

$${I}_{ℊ} ( s ) = [ \frac{{V}_{vs ℊ} ( s ) - {V}_{ℊ} ( s )}{{Z}_{vs ℊ} ( s )} ] [ \frac{1}{1 + {Z}_{ℊ} ( s ) / {Z}_{vs ℊ} ( s )} ] \qquad ( 16 )$$

From (16), it can be seen that a stable state of a system grid-connected current depends on a system impedance ratio, and when the positive and negative sequence impedances both satisfy a stability criterion, the system is stable. According to a passive theory, the conditions for system stability are that output phases are all within a range of [−90°, 90°]. Combined with the system sequence impedance model, it can be seen that: the system is stable when system output positive and negative sequence impedance phases are within a passive range.
S103: Introduce an active damping feedback loop into a voltage control link of a grid-forming converter in combination with the conditions for system stability and remodel an equivalent output impedance of converter resonance control to reduce a non-passive area of output positive and negative sequence impedances and achieve harmonic resonance suppression of a grid-connected current of the grid-forming converter.

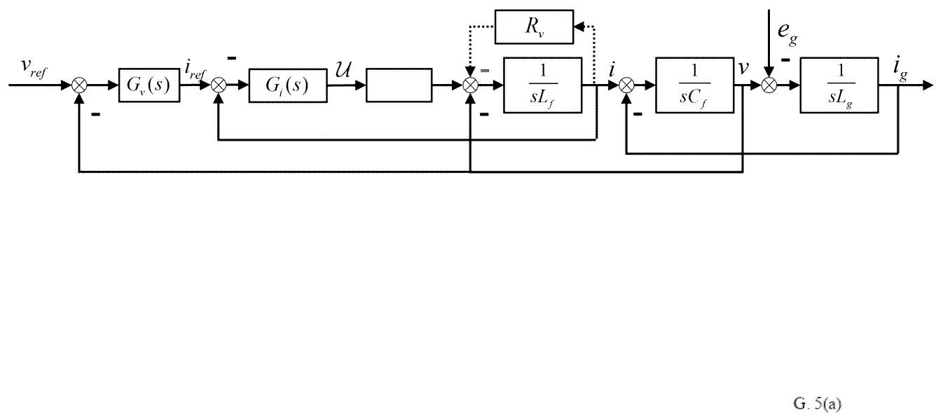

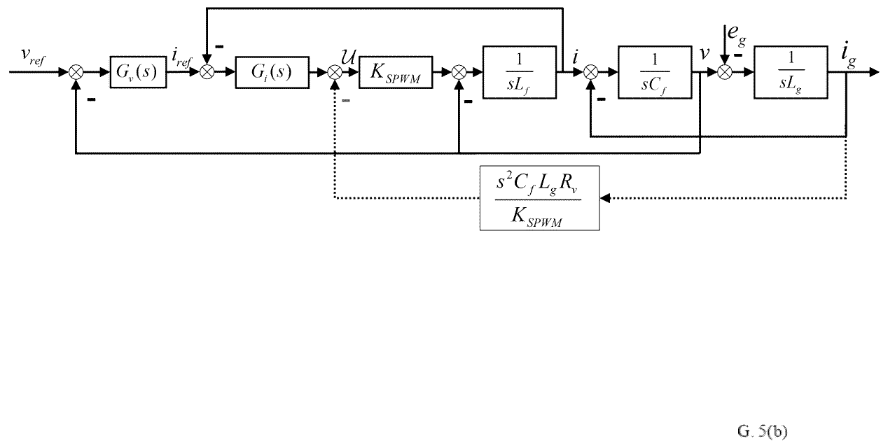

FIG. 5(a) and FIG. 5(b) are control block diagrams of introducing series passive damping into a converter voltage and current control link and equivalently converting the series passive damping to an active damping feedback loop, and system output sequence impedances are remodeled by increasing the system passivity. The current loop feedback introduced at this time can be simplified as s²Kₐ, Kₐ is used as active damping parameters, and active damping control parameters are determined by combining a change of the system sequence impedance model. At this time, a voltage and current dual-closed-loop control process in a sequence impedance calculation model becomes:

$$\{ \begin{matrix}{Δ𝒰}_{d} ( s ) = {G}_{i} ( s ) ( Δ {i}_{d r e f} ( s ) - Δ {i}_{d} ( s ) ) - {ω}_{1} {L}_{f} Δ {i}_{q} ( s ) + Δ {v}_{d} ( s ) - {s}^{2} {K}_{a} Δ {i}_{ℊ d} ( s ) \\ {Δ𝒰}_{q} ( s ) = {G}_{i} ( s ) ( Δ {i}_{q r e f} ( s ) - Δ {i}_{q} ( s ) ) + {ω}_{1} {L}_{f} Δ {i}_{d} ( s ) + Δ {v}_{q} ( s ) - {s}^{2} {K}_{a} Δ {i}_{ℊ q} ( s )\end{matrix} \qquad ( 17 )$$

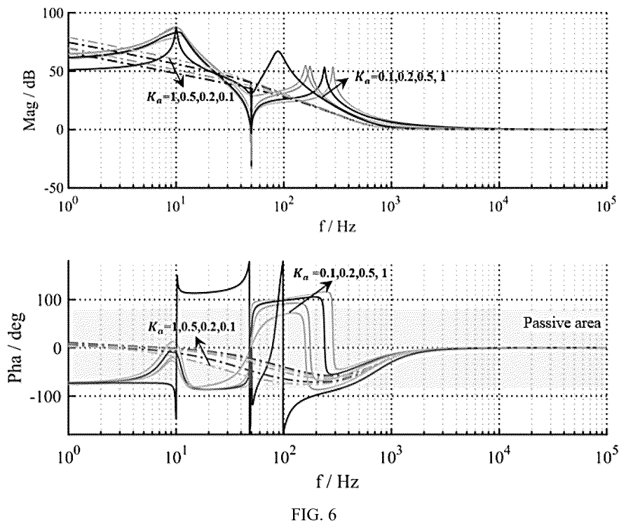

FIG. 6 is a variation curve of a system output sequence impedance with an active damping parameter after active damping is introduced, where a solid line represents a positive sequence impedance and a dashed line represents a negative sequence output impedance. A proportion of a passive area occupied by the system output sequence impedance varies with the active damping parameters, a parameter that maximizes a system passive output sequence impedance within a passive area is selected to further improve the model and enhance the system robustness. According to FIG. 6, 0.1 Or 0.2 can be selected as the parameter of Kₐ, at which time a passive area where the system sequence impedance is located is maximized.

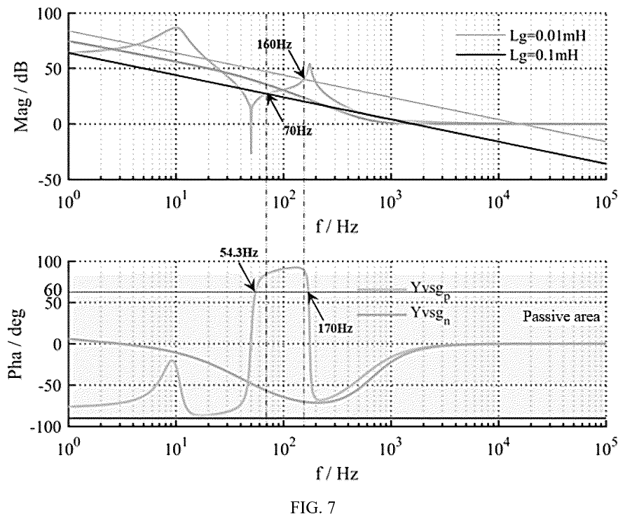

FIG. 7 is an interaction characteristic diagram of a system sequence impedance and a grid-side inductance when 0.2 is selected as the active damping parameter. In order to leave a phase margin of 30° as much as possible when the system is grid-connected and improve the system robustness, a virtual equivalent notch filter may be introduced.

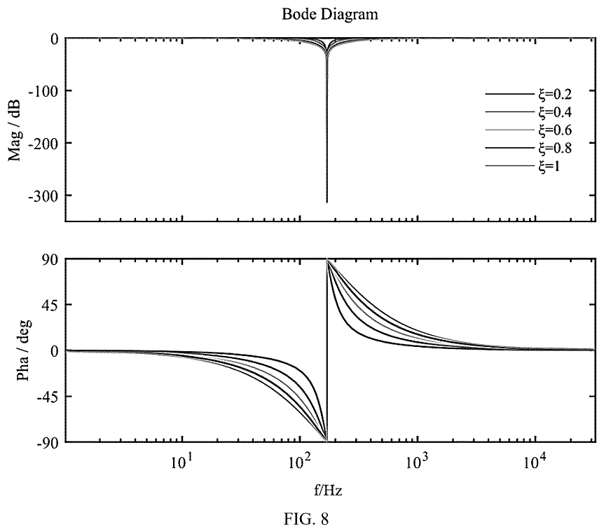

FIG. 8 is a notch filter action waveform, and a model G_{Nor} of which is as follows:

$${G}_{Nor} ( s ) = \frac{{s}^{2} + {ω}_{2}^{2}}{{s}^{2} + 2 s ξ {ω}_{2} + {ω}_{2}^{2}} \qquad ( 18 )$$

where ξ is a notch width, ω₂ is a notch center angular frequency, ω₂ is determined by a sequence impedance output waveform after active damping is added into the system and an intersection point of the sequence impedance output waveform with a grid-side inductance. From a system sequence impedance and a grid interaction output waveform in FIG. 7, 170 Hz can be taken as the notch filter center angular frequency.

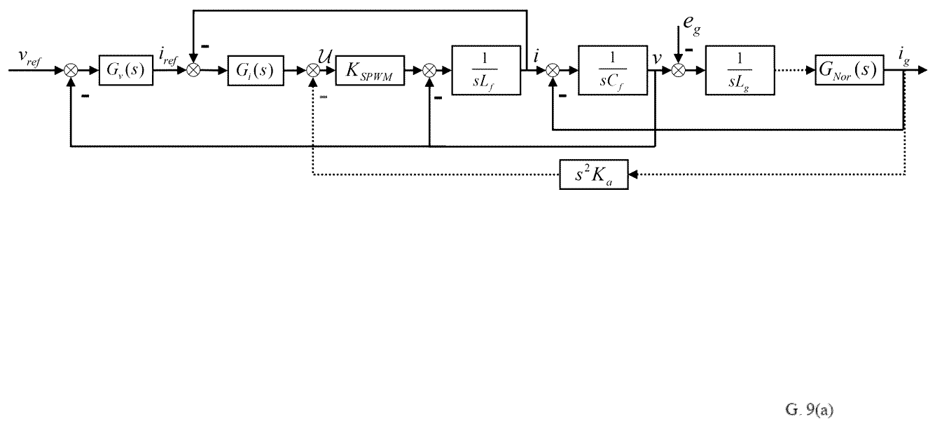

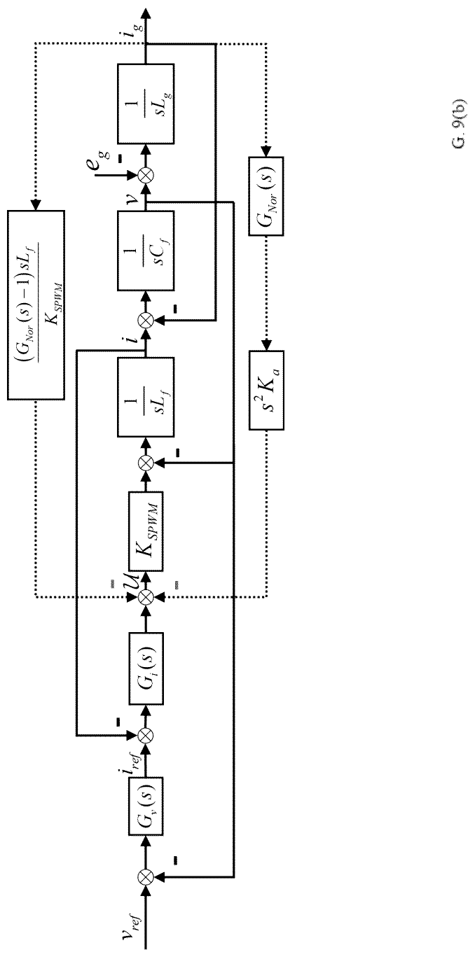

FIG. 9(a) and FIG. 9(b) show changes of block diagrams of voltage and current control when the notch filter is introduced into the grid-forming converter system. By simulating an effect of a grid-side series notch filter and equivalently incorporating the effect into voltage and current control loops, the effect is manifested as being added to a virtual notch filter control loop, thereby remolding the system output sequence impedance waveform to ensure that an output sequence impedance has a sufficient phase margin. At this time, a voltage and current dual-closed-loop control process in a sequence impedance calculation model is:

$$\{ \begin{matrix}{Δ𝒰}_{d} ( s ) = {G}_{i} ( s ) ( Δ {i}_{d r e f} ( s ) - Δ {i}_{d} ( s ) ) - {ω}_{1} {L}_{f} Δ {i}_{q} ( s ) + Δ {v}_{d} ( s ) - ( {s}^{2} {K}_{a} + {sL}_{f} ) {G}_{Nor} ( s ) Δ {i}_{ℊ d} ( s ) + {sL}_{f} Δ {i}_{ℊ d} ( s ) \\ {Δ𝒰}_{q} ( s ) = {G}_{i} ( s ) ( Δ {i}_{q r e f} ( s ) - Δ {i}_{q} ( s ) ) + {ω}_{1} {L}_{f} Δ {i}_{d} ( s ) + Δ {v}_{q} ( s ) - ( {s}^{2} {K}_{a} + {sL}_{f} ) {G}_{Nor} ( s ) Δ {i}_{ℊ q} ( s ) + {sL}_{f} Δ {i}_{ℊ q} ( s )\end{matrix} \qquad ( 19 )$$

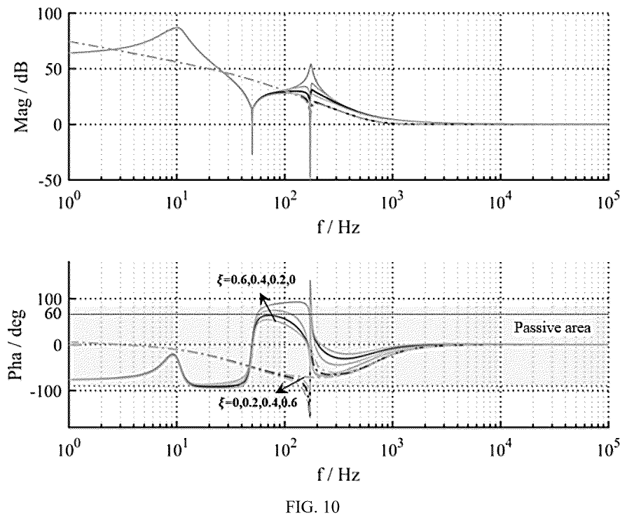

FIG. 10 shows a waveform of a system output sequence impedance varying with a ξ parameter after introducing a virtual notch filter feedback loop. At this time, the system output sequence impedance is basically within the passive area. 0.4 or 0.6 can be selected as a notch width of the notch filter according to the system, at which time an output impedance has a large phase margin that can increase the system stability and a robustness.

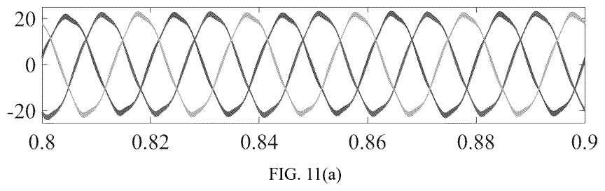

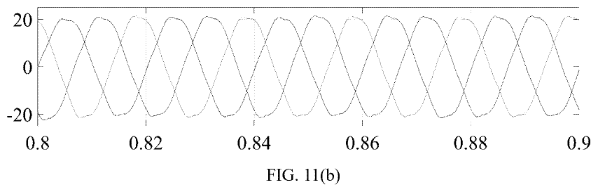

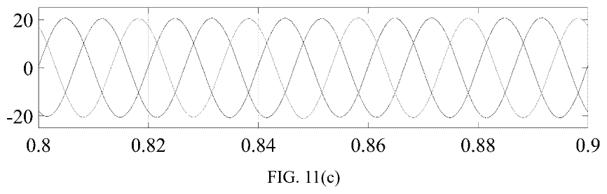

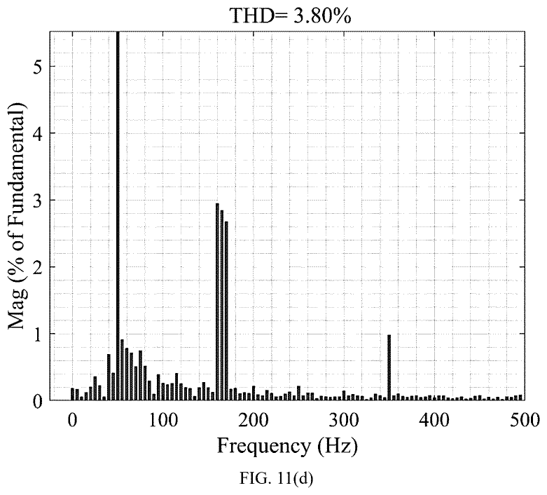

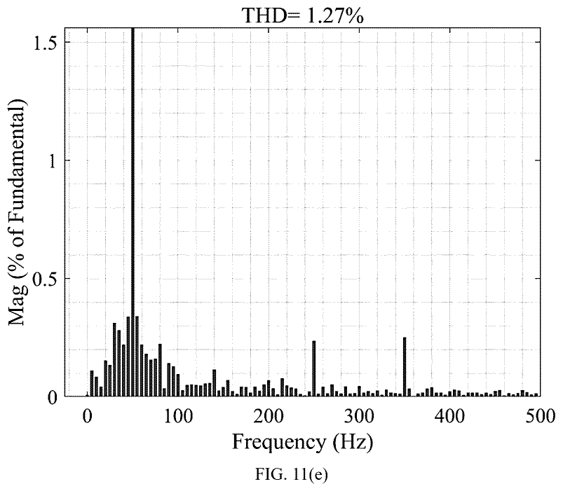

In order to verify an effect of a control method disclosed herein, an experimental simulation is performed, and simulation results are shown in FIG. 11(a), FIG. 11(b), FIG. 11(c), FIG. 11(d), and FIG. 11(e). FIG. 11(a) shows a grid-side output current waveform diagram of the grid-forming converter system before harmonic suppression, with a serious harmonic phenomenon in a current; in FIG. 11(b), partial output current harmonics are suppressed by introducing an active damping feedback loop; in FIG. 11(c), the system output current harmonics are obviously suppressed by introducing the virtual notch filter; and a comparison between FIG. 11(d) and FIG. 11(e) shows that introducing a new feedback loop specifically reduces a current harmonic content after introducing active damping.

In summary, the present embodiment clarifies a system stability mechanism by combining with a passive theory while reducing a modeling difficulty, and simultaneously introduces a feedback loop specifically according to a sequence impedance model to remodel the system impedance, thereby suppressing the system harmonic resonance, and improving the system stability and robustness.

### Embodiment 2

In one or more implementations, disclosed is a resonance suppression system for a grid-forming converter system based on sequence impedance remodeling, including:
a model building module for obtaining grid-side voltage, grid-side current and converter-side current small signals after linearization based on a grid-forming converter active and reactive control strategy and a voltage and current dual-closed-loop control principle, and building a sequence impedance model of a grid-forming converter system output impedance based on a virtual synchronous generator;
a stability analysis module for determining conditions for system stability based on the sequence impedance model in combination with a passive theory; and
a resonance suppression module for introducing an active damping feedback loop into a voltage control link of a grid-forming converter in combination with the conditions for system stability and remodeling an equivalent output impedance of converter resonance control to reduce a non-passive area of output positive and negative sequence impedances and achieve harmonic resonance suppression of a grid-connected current of the grid-forming converter.

It should be noted that a specific implementation of each of the above modules is the same as that in Embodiment 1 and will not be described in detail.

### Embodiment 3

In one or more implementations, disclosed is terminal equipment, including a processor and a memory, the processor is used for implementing instructions, the memory is used for storing a plurality of instructions, the instructions are adapted to be loaded by the processor and to execute the resonance suppression method for a grid-forming converter system based on sequence impedance remodeling according to Embodiment 1.

It should be understood that in the present embodiment, the processor may be a central processing unit CPU, and the processor may also be another general processor, a digital signal processor DSP, an application specific integrated circuit ASIC, an off-the-shelf programmable gate array FPGA or another programmable logic device, a discrete gate or a transistor logic device, a discrete hardware component, etc. The general-purpose processor may be a microprocessor or the processor may also be any conventional processor or the like.

The memory may include a read-only memory and a random access memory, and provide instructions and data to the processor, and a portion of the memory may also include a non-volatile random access memory. For example, the memory may also store device type information.

In an implementation process, each step of the above method may be completed through an integrated logic circuit of a hardware in the processor or an instruction in a software form.

### Embodiment 4

In one or more implementations, disclosed is a computer-readable storage medium having a plurality of instructions stored therein, the instructions are adapted to be loaded by a processor of terminal equipment and to execute the resonance suppression method for a grid-forming converter system based on sequence impedance remodeling according to Embodiment 1.

The above describes the specific implementations of the present disclosure with reference to the accompanying drawings, but is not intended to limit the protection scope of the present disclosure. Those skilled in the art should understand that any modifications or transformations made by those skilled in the art without creative efforts still fall within the protection scope of the present disclosure based on the technical solutions of the present disclosure.

What is claimed is:

1. A resonance suppression method for a grid-forming converter system based on sequence impedance remodeling, comprising:
obtaining grid-side voltage, grid-side current and converter-side current small signals after linearization based on a grid-forming converter active and reactive control strategy and a voltage and current dual-closed-loop control principle, and building a sequence impedance model of a grid-forming converter system output impedance based on a virtual synchronous generator;
determining conditions for system stability based on the sequence impedance model in combination with a passive theory; and
introducing an active damping feedback loop into a voltage control link of a grid-forming converter in combination with the conditions for system stability and remodeling an equivalent output impedance of converter resonance control to reduce a non-passive area of output positive and negative sequence impedances and achieve harmonic resonance suppression of a grid-connected current of the grid-forming converter.

2. The resonance suppression method for a grid-forming converter system based on sequence impedance remodeling according to claim 1, wherein specific processes of building the sequence impedance model of the grid-forming converter system output impedance based on the virtual synchronous generator are as follows:
building a nonlinear relationship model of an internal potential, an output terminal voltage and an output current of the grid-forming converter based on the grid-forming converter active and reactive control strategy and the voltage and current dual-closed-loop control principle;
injecting positive sequence and negative sequence disturbance voltages on a grid side of the grid-connected system, and performing harmonic linearization processing on the nonlinear model to respectively obtain the grid-side voltage, grid-side current and converter-side current small signals; and
enabling the small signals to traverse an active and reactive control process and a voltage and current dual-closed-loop control process of the grid-forming converter, and building the sequence impedance model of positive sequence and negative sequence grid-forming converter output impedances in a static coordinate system.

3. The resonance suppression method for a grid-forming converter system based on sequence impedance remodeling according to claim 2, after enabling the small signals to traverse the active and reactive control process and the voltage and current dual-closed-loop control process of the grid-forming converter, further comprising:
respectively substituting dq-axis grid-side voltage small signals Δv_{d} and Δv_{q}, dq-axis grid-side current small signals Δi_{gd} and Δi_{gq}, and inverter-side current small signals Δi_{d} and Δi_{q} obtained after the harmonic linearization processing into active frequency modulation, reactive voltage regulation and current and voltage control processes, and then substituting an obtained small signal model into a converter main circuit equation to obtain the sequence impedance model of the positive sequence and negative sequence grid-forming converter output impedances in the static coordinate system.

4. The resonance suppression method for a grid-forming converter system based on sequence impedance remodeling according to claim 1, wherein determining the conditions for system stability based on the sequence impedance model in combination with the passive theory is specifically performed as follows: the system is stable when system output positive and negative sequence impedance phases are both within a passive range.

5. The resonance suppression method for a grid-forming converter system based on sequence impedance remodeling according to claim 1, wherein after introducing the active damping feedback loop, the voltage and current dual-closed-loop control process becomes:
$$\{ \begin{matrix}{Δ𝒰}_{d} ( s ) = {G}_{i} ( s ) ( Δ {i}_{d r e f} ( s ) - Δ {i}_{d} ( s ) ) - {ω}_{1} {L}_{f} Δ {i}_{q} ( s ) + Δ {v}_{d} ( s ) - {s}^{2} {K}_{a} Δ {i}_{ℊ d} ( s ) \\ {Δ𝒰}_{q} ( s ) = {G}_{i} ( s ) ( Δ {i}_{q r e f} ( s ) - Δ {i}_{q} ( s ) ) + {ω}_{1} {L}_{f} Δ {i}_{d} ( s ) + Δ {v}_{q} ( s ) - {s}^{2} {K}_{a} Δ {i}_{ℊ q} ( s )\end{matrix} ;$$
wherein ω₁ is a rated angular frequency, LA is a converter-side series inductance, s²Kₐ represents introduced active damping feedback, and Kₐ is an active damping parameter; and ΔU_{d}(s) and ΔU_{q}(s) are respectively small signals after dq-axis modulation voltage linearization, Gᵢ(s) is a current loop transfer function, Δi_{dref}(s) and Δi_{qref}(s) are respectively reference current input of dq-axis current loop linearization small signals, Δi_{d} and Δi_{q} are respectively inverter-side current small signals obtained after harmonic linearization processing, Δv_{d}(s) and Δv_{q}(s) are respectively dq-axis grid-side voltage small signals obtained after harmonic linearization processing, and Δi_{gd}(s) and Δi_{gq}(s) are respectively dq-axis grid-side current small signals obtained after harmonic linearization processing.

6. The resonance suppression method for a grid-forming converter system based on sequence impedance remodeling according to claim 1, further comprising: introducing a virtual notch filter in a voltage and current control link of the grid-forming converter, such that output positive and negative sequence impedances meet a phase margin requirement.

7. The resonance suppression method for a grid-forming converter system based on sequence impedance remodeling according to claim 6, wherein after introducing the virtual notch filter, the voltage and current dual-closed-loop control process becomes:
$$\{ \begin{matrix}{Δ𝒰}_{d} ( s ) = {G}_{i} ( s ) ( Δ {i}_{d r e f} ( s ) - Δ {i}_{d} ( s ) ) - {ω}_{1} {L}_{f} Δ {i}_{q} ( s ) + Δ {v}_{d} ( s ) - ( {s}^{2} {K}_{a} + {sL}_{f} ) {G}_{Nor} ( s ) Δ {i}_{ℊ d} ( s ) + {sL}_{f} Δ {i}_{ℊ d} ( s ) \\ {Δ𝒰}_{q} ( s ) = {G}_{i} ( s ) ( Δ {i}_{q r e f} ( s ) - Δ {i}_{q} ( s ) ) + {ω}_{1} {L}_{f} Δ {i}_{d} ( s ) + Δ {v}_{q} ( s ) - ( {s}^{2} {K}_{a} + {sL}_{f} ) {G}_{Nor} ( s ) Δ {i}_{ℊ q} ( s ) + {sL}_{f} Δ {i}_{ℊ q} ( s )\end{matrix} ;$$
wherein ω₁ is a rated angular frequency, L_{f} is a converter-side series inductance, s²Kₐ represents introduced active damping feedback, and Kₐ is an active damping parameter; G_{Nor}(s) is a notch filter model; and ΔU_{d}(s) and ΔU_{q}(s) are respectively small signals after dq-axis modulation voltage linearization, Gᵢ(s) is a current loop transfer function, Δi_{dref}(s) and Δi_{qref}(s) are respectively reference current input of dq-axis current loop linearization small signals, Δi_{d} and Δi_{q} are respectively inverter-side current small signals obtained after harmonic linearization processing, Δv_{d}(s) and Δv_{q}(s) are respectively dq-axis grid-side voltage small signals obtained after harmonic linearization processing, and Δi_{gd}(s) and Δi_{gq}(s) are respectively dq-axis grid-side current small signals obtained after harmonic linearization processing.

8. A resonance suppression system for a grid-forming converter system based on sequence impedance remodeling, comprising:
a model building module for obtaining grid-side voltage, grid-side current and converter-side current small signals after linearization based on a grid-forming converter active and reactive control strategy and a voltage and current dual-closed-loop control principle, and building a sequence impedance model of a grid-forming converter system output impedance based on a virtual synchronous generator;
a stability analysis module for determining conditions for system stability based on the sequence impedance model in combination with a passive theory; and
a resonance suppression module for introducing an active damping feedback loop into a voltage control link of a grid-forming converter in combination with the conditions for system stability and remodeling an equivalent output impedance of converter resonance control to reduce a non-passive area of output positive and negative sequence impedances and achieve harmonic resonance suppression of a grid-connected current of the grid-forming converter.

9. Terminal equipment, comprising a processor and a memory, the processor being used for implementing instructions, and the memory being used for storing a plurality of instructions, wherein the instructions are adapted to be loaded by the processor and to execute the resonance suppression method for a grid-forming converter system based on sequence impedance remodeling according to claim 1.

10. A computer-readable storage medium, having a plurality of instructions stored therein, wherein the instructions are adapted to be loaded by a processor of terminal equipment and to execute the resonance suppression method for a grid-forming converter system based on sequential impedance remodeling according to claim 1.
